(19) United States
(12) Patent Application Publication
(10) Pub. No.: US 2005/0051191 A1
(43) Pub. Date: Mar. 10, 2005

(54) [CLEANING METHOD USED IN INTERCONNECT PROCESS]

(76) Inventors: Shih-Chieh Kao, Keelung (TW); Jin-Tau Huang, Taoyuan (TW); Yi-Nan Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,081

(22) Filed: Nov. 20, 2003

(30) Foreign Application Priority Data
Sep. 9, 2003 (TW) 92124833

(51) Int. Cl. B08B 11/00

(52) U.S. Cl. 134/1.1; 134/2; 134/25.4; 134/26

(57) ABSTRACT

A cleaning method used in the fabrication of metallic interconnects is provided. A substrate having a conductive layer and a dielectric layer on the conductive layer is provided. An opening is formed in the dielectric layer. The opening exposes a portion of the conductive layer. The opening is cleaned using a mixture containing sulfuric acid and hydrogen peroxide. In this invention, the mixture containing sulfuric acid and hydrogen peroxide provides an effective means of removing the residues within the opening so that the electrical conductivity of a subsequently formed contact is improved.

### CROSS REFERENCE TO RELATED APPLICATIONS

This application claims the priority benefit of Taiwan application serial no. 92124833, filed Sep. 9, 2003.

### BACKGROUND OF INVENTION

1. Field of the Invention

The present invention relates to a cleaning method used in semiconductor fabrication. More particularly, the present invention relates to a cleaning method used in interconnect process.

2. Description of the Related Art

With rapid advance in semiconductor technologies, devices having smaller dimensions are produced. When the level of integration of circuits increases, a chip often run out of surface area for accommodating interconnecting wires. To match the increase demand for interconnects with the miniaturization of devices, a multi-layered interconnect wiring layout design is used to fabricate very large scale integration (VLSI) circuits. When an electrical connection between different metallic layers is required, a contact opening is formed by etching the inter-layer dielectric between the two metallic layers and depositing conductive material to form a contact structure. Through the contact structure, the two metallic layers are electrically connected.

In the process of fabricating interconnects, a post-etching cleaning operation is often carried out after an opening is etching out of a dielectric layer so that any residue within the opening is removed before conductive material is deposited into the opening. At present, organic alkaline solution is frequently used in interconnect process for post-etch cleaning. However, organic alkaline solution is costly and the waste after the cleaning process is difficult to dispose with due to environmental concerns. Furthermore, organic alkaline solution is not very effective in removing high molecular weight residues. When the contact opening is not thoroughly cleaned, resistance of subsequently formed contact is likely to increase.

Another commonly used cleaning agent in interconnect process is inorganic acid or inorganic alkaline solution. However, inorganic acid or inorganic alkaline type of compound has a relatively high etching rate. Hence, when these types of cleaning solution are used to clean contact openings, during of the cleaning step must be carefully controlled. If one is not careful in setting the processing parameter, the metallic layer underneath the opening may be over-etched leading to an increase in resistance of the metallic layer.

### SUMMARY OF INVENTION

Accordingly, one object of the present invention is to provide a cleaning method used in an interconnect process in which the usage of conventional organic alkaline solution can be avoided and the inability to remove unwanted residue completely can be resolved.

A second object of the present invention is to provide a cleaning method used in an interconnect process in which the risk of over etching the conductive structure within the opening during the cleaning treatment using an inorganic acid or an inorganic alkaline solution can be significantly reduced or eliminated.

A third object of the present invention is to provide a cleaning method used in an interconnect process in which the high resistance of conductive structure produced through a conventional cleaning method can be effectively prevented.

To achieve these and other advantages and in accordance with the purpose of the invention, as embodied and broadly described herein, the invention provides a cleaning method used in an interconnect process. First, a substrate having a conductive layer and a dielectric layer thereon is provided. The conductive layer is formed over the substrate and the dielectric layer is formed over the conductive layer. Thereafter, a photolithographic process and an etching process are carried out in sequence to form an opening in the dielectric layer. The opening exposes a portion of the conductive layer. Since the etching process produces a large quantity of high molecular weight residues around the opening, a cleaning process is performed before depositing any conductive material into the opening. In this invention, a mixture containing sulfuric acid and hydrogen peroxide is used as a cleaning solution. The concentration of the sulfuric acid in the mixture is about in between 0.1M to 0.2M and the concentration of the hydrogen peroxide in the mixture is about in between 1.1M to 2.0M. In addition, the process of cleaning the opening using the mixture of sulfuric acid and hydrogen peroxide is carried out at a temperature between 30° C. to 40° C., preferably at 34° C., for a period between 30 to 90 seconds. Using the special cleaning solution and the processing conditions according to this invention, high molecular weight residues are removed without over-etching any underlying conductive layer. Hence, this invention provides an effective and easy to control cleaning process.

This invention also provides a method of forming interconnects. First, a substrate having a dielectric layer formed thereon is provided. Thereafter, a photolithographic process and an etching process are carried out in sequence to form an opening in the dielectric layer. A cleaning process is performed to remove any high molecular weight residues around the opening. In this invention, a mixture containing sulfuric acid and hydrogen peroxide is used to clean the opening. The concentration of the sulfuric acid in the mixture is about in between 0.1M to 0.2M and the concentration of the hydrogen peroxide in the mixture is about in between 1.1M to 2.0M. In addition, the process of cleaning the opening using the mixture of sulfuric acid and hydrogen peroxide is carried out at a temperature between 30° C. to 40° C., preferably at 34° C., for a period between 30 to 90 seconds. After the opening is cleaned, conductive material is deposited into the opening to form a conductive structure. The conductive structure is, for example, a contact (also referred to as a via), a dual damascene structure, or a conductive wire.

This invention provides an effective means of removing any high molecular weight resides within the opening. Hence, the resistance of any subsequently formed conductive structure inside the opening is reduced.

The sulfuric acid and hydrogen peroxide in the mixture for performing the cleaning process is more cost effective compared to the organic alkaline solution used in a conventional cleaning process. Furthermore, the waste effluents of the cleaning process is easier to treat and handle.

Since the conductive layer at the bottom of the opening is prevented from over-etching when the cleaning mixture is applied and under conditions for cleaning the opening according to this invention, and therefore the cleaning process is easier to control.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A through 1D are schematic cross-sectional views showing the steps of forming a contact according to a first preferred embodiment of this invention.

FIGS. 2A through 2C are schematic cross-sectional views showing the steps of forming a contact according to a second preferred embodiment of this invention.

FIGS. 3A through 3C are schematic cross-sectional views showing the steps of forming a dual damascene structure according to a third preferred embodiment of this invention.

FIGS. 4A through 4C are schematic cross-sectional views showing the steps of forming a conductive line according to a fourth preferred embodiment of this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

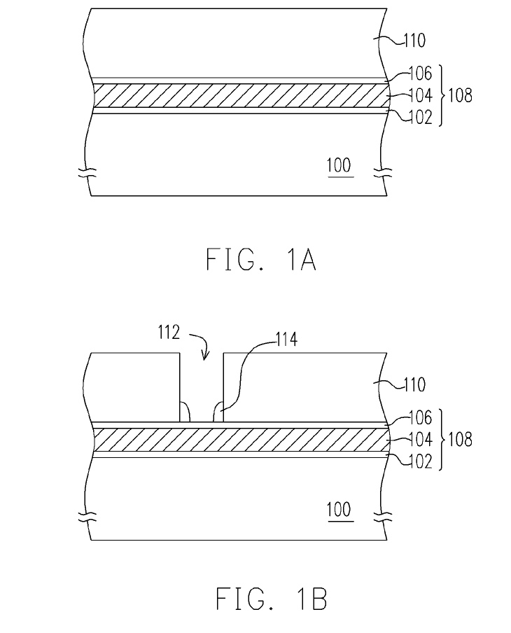

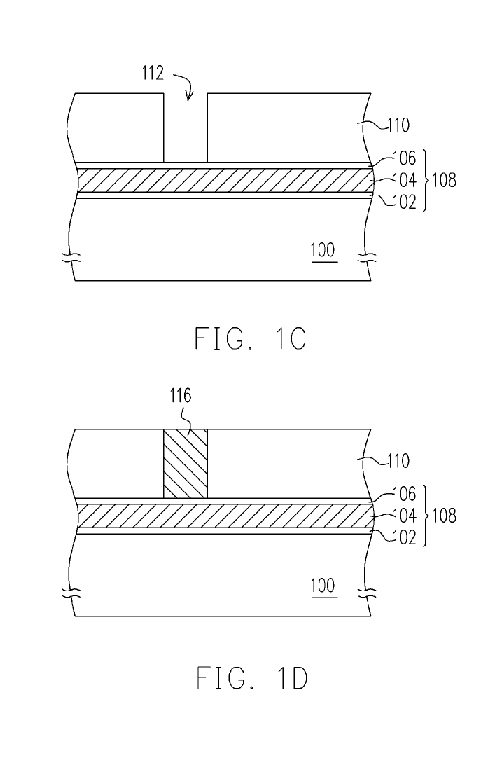

FIGS. 1A through 1D are schematic cross-sectional views showing the steps forming a contact according to a first preferred embodiment of this invention. As shown in FIG. 1A, a substrate 100 having a conductive layer 108 and a dielectric layer 110 formed thereon is provided. The conductive layer 108 is formed over the substrate 100 and the dielectric layer 110 is formed over the conductive layer 108. The conductive layer 108 has a sandwiched structure that includes a titanium/titanium nitride layer 102, an aluminum/copper alloy layer 104 and a titanium/titanium nitride layer 106, for example. The dielectric layer 110 is a silicon oxide layer formed, for example, by performing a high-density plasma chemical vapor deposition (HDP-CVD). In general, the conductive layer 108 and the dielectric layer 110 can be fabricated using a material other than the aforementioned examples.

As shown in FIG. 1B, a photolithographic process and an etching process are carried out in sequence to produce an opening 112 in the dielectric layer 110. The opening 112 exposes a portion of the conductive layer 108. If the etching process is carefully controlled, etching stops right on the titanium/titanium nitride layer 106 of the conductive layer 108. The etching process is a dry etching process, for example. However, after the etching process, a large quantity of high molecular weight residues 114 may remain around the bottom area of the opening 112.

As shown in FIG. 1C, a cleaning process is performed to remove the high molecular weight residues 114 inside the opening 112. In the cleaning process, a mixture containing sulfuric acid and hydrogen peroxide is used to clean the opening 112. In one embodiment of this invention, the concentration of the sulfuric acid in the mixture is about in between 0.1M to 0.2M and the concentration of the hydrogen peroxide in the mixture is about in between 1.1M to 2.0M. In other words, a cleaning solution with the aforementioned ingredient concentrations is produced through a proper mixing of the sulfuric acid, the hydrogen peroxide and water. Furthermore, the concentration of individual ingredient may be adjusted according to different processing environment. In addition, the process of cleaning the opening with the mixture of sulfuric acid and hydrogen peroxide is carried out at a temperature between 30° C. to 40° C., preferably at 34° C., for a period between 30 to 90 seconds.

As shown in FIG. 1D, a conductive material is deposited into the opening 112 to form a contact 116 such that the contact 116 and the conductive layer 108 are electrically connected.

Because the high molecular weight residues 114 within the opening 112 has already been removed in the cleaning process, the subsequently formed contact 116 formed within the opening 112 has an improved electrical conductivity. Furthermore, the cleaning solution is mild enough and does not etch into the conductive layer 108 and hence the cleaning process can be conveniently carried out without the risk of over etching the conductive layer.

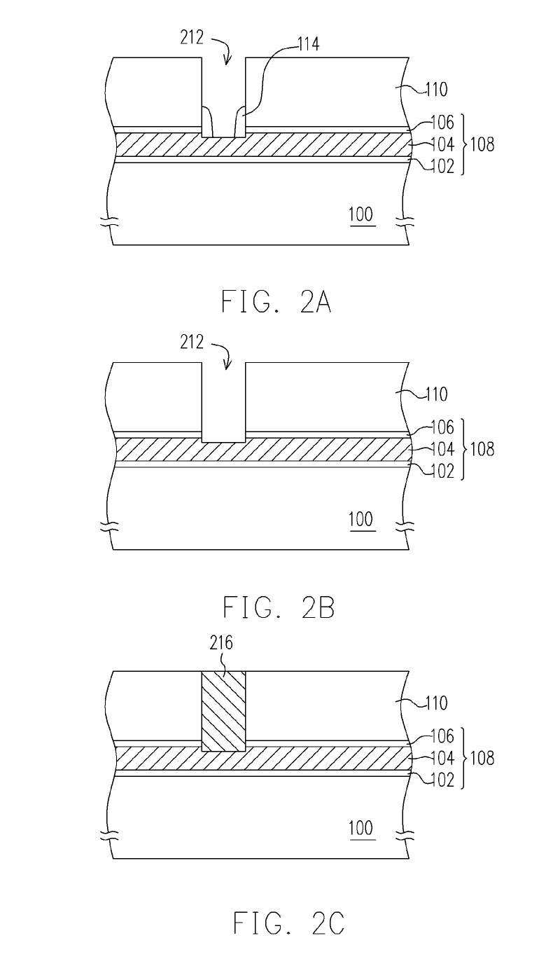

FIGS. 2A through 2C are schematic cross-sectional views showing the steps of forming a contact according to a second preferred embodiment of this invention. As described above with reference to FIG. 1A, a substrate 100 having a conductive layer 108 and a dielectric layer 110 formed thereon is provided, a photolithographic process and an etching process are carried out to form an opening 212 in the dielectric layer 110 as shown in FIG. 2A. In the second embodiment, the etching process not only etches through the titanium/titanium nitride layer 106 but also etches away a portion of the aluminum/copper alloy layer 104. Hence, the opening 212 exposes both the titanium/titanium nitride layer 106 and the aluminum/copper alloy layer 104 of the conductive layer 108. Similarly, a large quantity of high molecular weight residues 114 remain within the opening 212 after the etching process. If the residues 114 are permitted to remain within the opening 212, the profile of the opening 212 is likely to be adversely affected leading to an even higher resistance of the subsequently formed contact than that in the first embodiment. Therefore, an effective means of cleaning the residues 114 within the opening 212 is very crucial.

As shown in FIG. 2B, a cleaning process is performed to remove the residues 114 within the opening 212. In the cleaning process, a mixture containing sulfuric acid and hydrogen peroxide is used to clean the opening 212. The concentration of sulfuric acid and hydrogen peroxide in the mixture and the conditions for carrying out the cleaning operation are identical to one described in the previous embodiment.

As shown in FIG. 2C, a conductive material is deposited into the opening 212 to form a contact 216 such that the contact 216 and the conductive layer 108 are electrically connected.

Aside from cleaning contact openings in the fabrication of contacts, the cleaning process according to this invention can also be applied to fabricate other metallic interconnects such as a dual damascene structures and conductive lines.

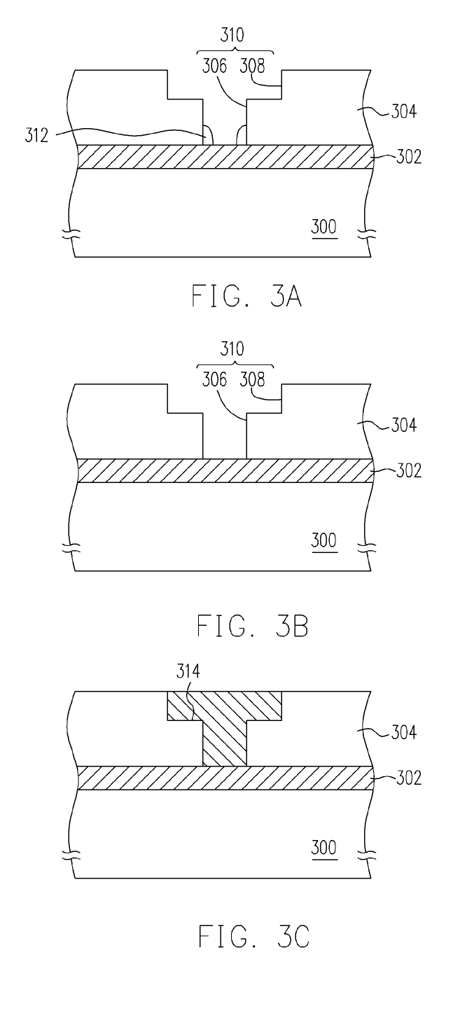

FIGS. 3A through 3C are schematic cross-sectional views showing the steps for producing a dual damascene structure according to a third preferred embodiment of this invention. As shown in FIG. 3A, a substrate 300 having a conductive layer 302 and a dielectric layer 204 formed thereon is provided. The conductive layer 302 and the dielectric layer 304 can be in a form of a variety of structures and can be fabricated using a variety of materials. Thereafter, a photolithographic process and an etching process are carried out in sequence to form a dual damascene opening 310 in the dielectric layer 304. The dual damascene opening 310 comprises a contact opening 306 and a trench 208. The contact opening 306 exposes the conductive layer 302. Obviously, the dual damascene opening 310 can be fabricated by forming the contact opening 306 before the trench 308 or forming the trench 308 before the contact opening 306. Similarly, some high molecular weight residues 312 are left behind around the bottom section of the dual damascene opening 310 after the etching process.

As shown in FIG. 3B, a cleaning process is performed to remove the residues 312 within the dual damascene opening 310. In the cleaning process, a mixture containing sulfuric acid and hydrogen peroxide is used to clean the opening 310. Since the concentration of sulfuric acid and hydrogen peroxide in the mixture and the conditions for carrying out the cleaning operation are identical to one described in the previous embodiment, and therefore detailed description thereof is omitted.

As shown in FIG. 3C, conductive material is deposited into the dual damascene opening 310 to form a dual damascene structure 314.

Because the high molecular weight residues 312 within the dual damascene opening 310 has already been removed in the cleaning process, the subsequently formed dual damascene structure 314 inside the opening 310 has an improved electrical conductivity. Furthermore, the cleaning solution is mild enough and does not etch into the conductive layer 302 and hence the cleaning process can be carried out conveniently without the risk of over etching the conductive layer 302.

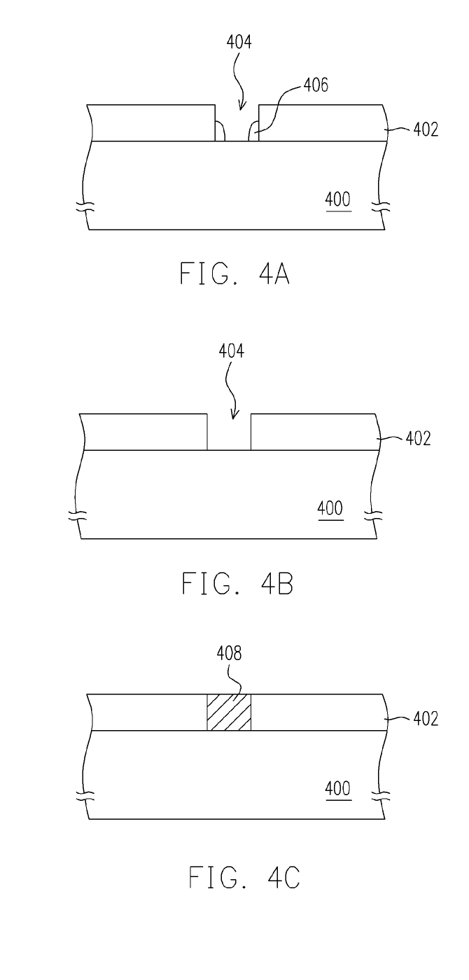

FIGS. 4A through 4C are schematic cross-sectional views showing the steps of forming a conductive line according to a fourth preferred embodiment of this invention. As shown in FIG. 4A, a substrate 400 having a dielectric layer 402 thereon is provided. Thereafter, a photolithographic process and an etching process are carried out in sequence to pattern the dielectric layer 402 so that a trench 404 is formed in the dielectric layer 402. However, during the etching process, some high molecular weight residues 406 may be produced and are left behind within the trench 404.

As shown in FIG. 4B, a cleaning process is performed to remove the residues 406 within the trench 404. In the cleaning process, a mixture containing sulfuric acid and hydrogen peroxide is used to clean the trench 404. Since the concentration of sulfuric acid and hydrogen peroxide in the mixture and the conditions for carrying out the cleaning operation are identical to one described in the previous embodiment, and therefore detailed description thereof is omitted.

As shown in FIG. 4C, conductive material is deposited into the trench 404 to form a conductive line 408.

Since the cleaning process according to this invention is very effective in removing the high molecular weight residues 406 from the trench 404, the subsequently formed conductive line 408 within the trench 404 will have good electrical conductivity.

In summary, major advantages of this invention includes: 1. The cleaning process is very effective for removing high molecular weight residues from an opening so that subsequently formed conductive structure formed within the opening will have significantly lower resistance. 2. The cost of sulfuric acid and hydrogen peroxide is considerably lower than the conventional organic alkaline solution. Furthermore, the waste effluents generated during the cleaning process are easier to treat and dispose. 3. The cleaning solution is mild enough to prevent the conductive layer at the bottom of the opening from over-etching. Thus, the cleaning process is easier to control.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A cleaning method used in an interconnect process, comprising the steps of:
providing a substrate having a conductive layer and a dielectric layer formed thereon, wherein the conductive layer is formed over the substrate and the dielectric layer is formed over the conductive layer;
forming an opening in the dielectric layer to expose a portion of the conductive layer; and
cleaning the opening using a mixture containing sulfuric acid and hydrogen peroxide in water.

2. The cleaning method of claim 1, wherein the concentration of the sulfuric acid in the mixture is between 0.1M to 0.2M.

3. The cleaning method of claim 1, wherein the concentration of the hydrogen peroxide in the mixture is between 1.1M to 2.0M.

4. The cleaning method of claim 1, wherein the opening is cleaned using the mixture containing sulfuric acid and hydrogen peroxide heated to a temperature between 30° C. to 40° C.

5. The cleaning method of claim 1, wherein the opening is cleaned using the mixture containing sulfuric acid and hydrogen peroxide for a duration of about 30 to 90 seconds.

6. The cleaning method of claim 1, wherein the opening is a contact opening or a dual damascene opening.

7. The cleaning method of claim 1, wherein the conductive layer is a composite layer comprising a titanium/titanium nitride layer, an aluminum/copper alloy layer and another titanium/titanium nitride layer.

8. A cleaning method used in forming metallic interconnects, comprising the steps of:
providing a substrate having a dielectric layer formed thereon;
forming an opening in the dielectric layer;
cleaning the opening using a mixture containing sulfuric acid and hydrogen peroxide in water; and
depositing conductive material into the opening.

9. The method of claim 8, wherein a concentration of the sulfuric acid is between 0.1M to 0.2M.

10. The method of claim 8, wherein a concentration of the hydrogen peroxide is between 1.1M to 2.0M.

11. The method of claim 8, wherein the opening is cleaned using the mixture containing sulfuric acid and hydrogen peroxide heated to a temperature between 30° C. to 40° C.

12. The method of claim 8, wherein the opening is cleaned using the mixture containing sulfuric acid and hydrogen peroxide for a duration of about 30 to 90 seconds.

13. The method of claim 8, wherein the step of forming an opening in the dielectric layer comprises performing a photolithographic process and an etching process in sequence.

14. The method of claim 8, wherein the opening is a contact opening, a dual damascene opening or a trench.

15. A cleaning solution used in an interconnect process, comprising:
sulfuric acid, at a concentration between 0.1M to 0.2M;
hydrogen peroxide, at a concentration between 1.1M to 2.0M; and
purified water.
